(19) United States
(12) Patent Application Publication
(10) Pub. No.: US 2003/0074816 A1
(43) Pub. Date: Apr. 24, 2003

(54) Information medium

(76) Inventor: Fritz Brinkmann, Rettenbach (DE)

Correspondence Address: Crowell & Moring, PO Box 14300, Washington, DC, 20044-4300, US

(21) Appl. No.: 10/111,106

(22) PCT Filed: Jul. 12, 2001
(86) PCT No.: PCT/EP01/08073

(30) Foreign Application Priority Data
Aug. 22, 2000 (DE) 20014501.0

(51) Int. Cl. G09F 3/00

(52) U.S. Cl. 40/310

(57) ABSTRACT

The present invention relates to an information carrier provided for mounting on a bottle and/or on a bottle case, particularly on the lateral surfaces of a bottle case,

which information carrier (100) is formed of an adhesive foil, in particular, is punched out, and

which has an exterior side (10) facing away from the bottle and/or from the bottle case as well as an interior side (30) facing the bottle and/or the bottle case.

The present invention relates to an information carrier.

Such information carriers, which, depending on their respective purpose and their respective usage, can also act as advertising media, are mounted on a bottle, for example, on bottles for alcoholic beverages (beer, wine, other alcoholic beverages, and the like) or for non-alcoholic beverages (mineral water, refreshments, juice and the like) in order to inform the interested party or (potential) buyer of the content of the bottle as well as of the manufacturer of the content of the bottle.

The same essentially applies to an information carrier to be mounted on a bottle case, particularly the lateral surfaces or side walls of the bottle case being suitable for the mounting of such information carriers.

A label is known which is coated with glue on its underside at least in sections and/or at least in areas and which is provided for mounting on an object, particularly on a bottle case. In this case, the glue is UV-cross-linked and is essentially insoluble in a washing solution, particularly in water (compare German Patent Document DE 298 03 159 U1).

Concerning this known label, it should be noted that it is based substantially on a mounting of the label by means of glue. If the bottle cases ready for the transport are, for example, left in the sun, which nowadays often occurs in loading yards of filling enterprises and breweries despite thought-out logistics, the glue situated between the lateral surface of the bottle case and the underside of the label will expel gas because of the heat development, which results in a visually unattractive bubble formation even before the bottle case together with its content reaches the market.

In the case of the labels based on a glue-type mounting, difficulties also frequently occur because of an insufficient dispensing capability as a result of glue residues on the lateral surface of the of the box case and because of a lack of recycling capacity of the removed label.

Based on the above-mentioned disadvantages and insufficiencies, it is an object of the present invention to provide an information carrier which, on the one hand, is and remains visually attractive under any environmental conditions and weather-related influences and, on the other hand, can be dispensed in a simple manner and without any problems onto the respective object, for example, onto a bottle and/or onto a bottle case. Furthermore, the present invention aims at providing an information carrier which can easily and without any (glue) residues be removed again from the respective object, for example, from a bottle and/or from a bottle case and, after the removal, can be recycled in a cost-effective and environmentally harmless manner.

In the case of an information carrier of the initially mentioned type, this object is achieved in that the information carrier according to the teaching of the present invention is formed of an adhesive foil, in particular, is punched out, and has an exterior side facing away from the bottle and/or from the bottle case as well as an interior side facing the bottle and/or the bottle case.

In that the information carrier according to the teaching of the present invention is formed of an adhesive foil, in particular, is punched out, and no glue is therefore required between the lateral surface of the bottle case and the interior side of the information carrier, it is surprisingly ensured that the information carrier remains visually attractive under any environmental conditions and weather-related influences.

Furthermore, the above-mentioned adhesive foil characteristic permits a simple and problem-free automatic and/or mechanical dispensing of the information carrier, which, in the top view, preferably has an approximately rectangular construction, onto the respective object, for example, onto a bottle and/or onto a bottle case, for example, by means of a dispensing device designed for this purpose.

In this context, the person skilled in the art will particularly appreciate that the carrier material, which may be made of paper and/or may contain plastic, for the information carrier—in contrast to the corresponding known labels (compare German Patent Document DE 298 03 159 U1)—does not have to be siliconized or otherwise pretreated on the side facing the information carrier, so that according to the teaching of the present invention, not only the information carrier itself but also the carrier material can be recycled in a cost-effective and environmentally harmless manner and can therefore be returned the circulation of material.

Also, the adhesive foil characteristic not only promotes the capacity of the individual information carriers to be punched out of a web-shaped reel-type adhesive foil, for example, by means of flat punching or by means of rotatory punching, but also a problem-free and (glue) residue-free removal of the information carrier from the respective object, for example, from a bottle and/or from a bottle case, which takes place after the use of the information carrier.

Thus, independently of a possible, no longer up-to-date or no longer desired imprint on the lateral surfaces of the bottle case, the bottle case can be provided for each new use with information carriers whose imprint is individually adapted to the content of the bottle case and/or to certain marketing measures (prize games, competitions, special offers, free gifts, . . . ).

Not least in view of the rising merger trend also in the case of filling enterprises and breweries, this is a characteristic which is essential to the invention because the filling enterprise and the brewery will, as a result, no longer be limited to the frequently out-of-date, no longer appropriate and/or weathered imprint on the lateral wall of the bottle case without having to remove this imprint by high-expenditure mechanical measures which attack the substance of the bottle case (scratching-off, scraping-off, . . . ).

According to a particularly inventive further development, the interior side of the information carrier is at least partially provided with at least one stamping. As a result, the degree and/or the strength of the adhesion of the information carrier on the respective object, for example, on a bottle and/or on a bottle case, can be adjusted and defined. As an alternative or in addition, the information carrier can be at least partially provided with at least one perforation and/or with at least one punching.

According to a preferred embodiment of the present invention, the adhesive foil is constructed in one layer of a thermoplastic material which has at least two different plastic materials. As a result, the material-specific characteristics can be adjusted and parameterized as a function of the special purpose of the information carrier in a practical manner. Thus, the adhesive foil may, for example, have material regions which extend parallel to one another in the extrusion direction and which, in an alternating manner, may have a first and a second plastic material.

In an advantageous embodiment, the adhesive foil is stretched, particularly axially stretched or particularly biaxially stretched in order to provide the information carrier with the stiffness desired for the further processing, particularly for the dispensing onto the respective object.

Particularly favorable material characteristics of the information carrier can be achieved when, according to an expedient further development of the present invention,

the exterior side of the information carrier is formed of a first plastic material,

the interior side of the information carrier is formed of a second plastic material, and

the exterior side and the interior side are co-extruded or are laminated with one another by at least one bonding medium, for example, by at least one bonding agent.

Here, the first plastic material may be selected, for example, from the polyamide (PA), the polyethylene (PE), the polyethylene terephthalate (PET), the polypropylene (PP), the polystyrene (PS) and/or the polyurethane (PU) group; whereas the second plastic material, independently of the first plastic material or in connection with the first plastic material, may be selected from the ethylene butyl acrylate (EBA), the ethylene methyl acrylate (EMA), the ethylene vinyl acrylate (EVA), the polyisobutyl (PIB), the polyisomethyl (PIM), the polyisovinyl (PIV) group and/or from Surlyn. In this context, it should be noted that the second plastic material preferably providing the adhesive characteristics of the information carrier is added, for example, in the form of approximately 56% ethylene vinyl acrylate (EVA) or in the form of approximately 4% polyisobutyl (PIB) (→melting index MI approximately equal to 1).

The above-mentioned bonding medium can expediently be based on at least one copolymer. In particular, the material of the bonding medium may be selected from the ethylene butyl acrylate (EBA), the ethylene methyl acrylate (EMA), the ethylene vinyl acrylate (EVA) group and/or from Surlyn.

In order to ensure a particularly intimate connection between the first plastic material and the second plastic material, the melting temperature TV (for example, in the order of approximately 120° C.) of the bonding medium in a preferable embodiment is lower than the melting temperature TK (for example, in the order of approximately 220° C.) of the first plastic material and of the second plastic material.

As an alternative or in addition, at least one gluing agent can also be provided as a bonding medium, such as

at least one cold gluing agent and/or

at least one thermally active gluing agent (so-called hot melt gluing agent). Finally, the selection of an adequate bonding medium will depend on the desired purpose and on the required material characteristics of the information carrier.

As mentioned above, the information carrier according to a particularly inventive further development has at least one imprint. This imprint can provide not only general information concerning the content of the bottle case or concerning the manufacturer of the content of the bottle case but also target information concerning special advertising measures (prize games, competitions, special offers, free gifts, . . . ). It may be advantageous for this purpose to provide the information carrier at least partially with an opaque structure.

As a alternative or in addition, the information carrier, on its exterior side and/or on its interior side, can be

at least partially transparent and/or

at least partially dyed and/or

at least partially imprinted and/or

at least partially coated and/or

at least partially inscribed.

In particular, the information carrier can be

at least partially preferably be dyed white and/or

at least partially be imprinted with a preferably white color, and/or

at least partially be coated with a preferably white paint, for example, for better setting off the imprinted region of the information carrier or the imprinted area of the information carrier.

According to an expedient further development of the present invention, the imprinted region of the information carrier or the imprinted area of the information carrier is imprinted by letter press printing, by flexo-printing, by counterprinting, by offset printing, by silk screen printing and/or by photogravure printing.

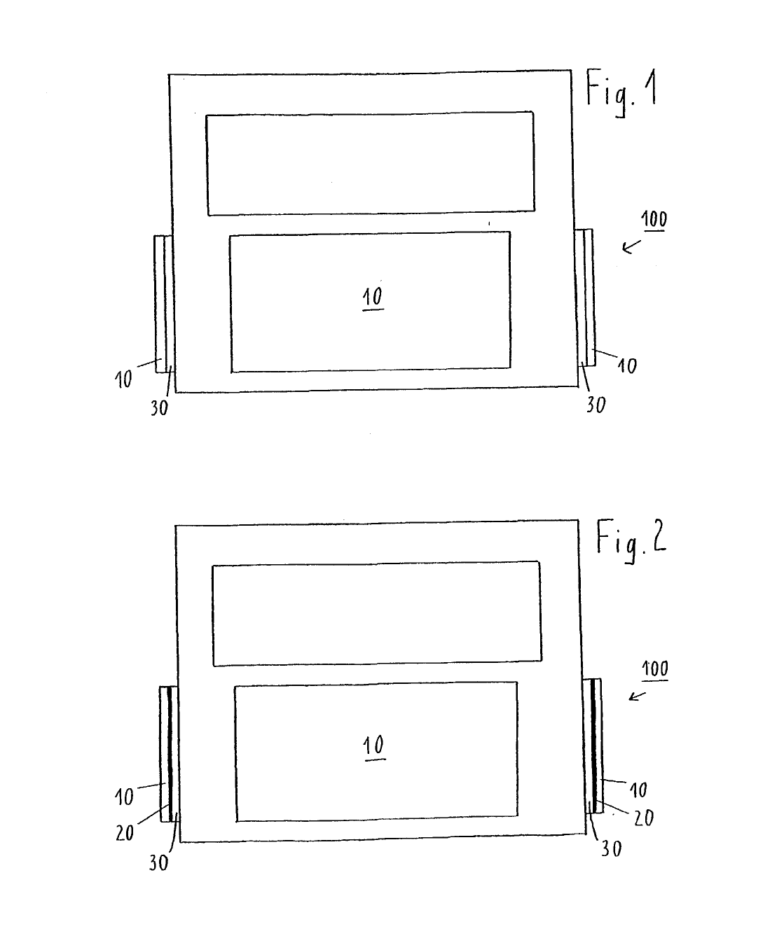

Further developments, characteristics and advantages of the present invention will be described in the following by means of FIGS. 1 and 2, which illustrate two embodiments of the invention as examples.

FIG. 1 is a lateral top view of a first embodiment of information carriers according to the present invention mounted on the lateral walls of a bottle case; and

FIG. 2 is a lateral top view of a second embodiment of information carriers according to the present invention mounted on the lateral walls of a bottle case.

Identical reference numbers refer to identically or similarly constructed elements or characteristics in FIGS. 1 and 2.

FIGS. 1 and 2 are lateral top views of two embodiments of information carriers 100 mounted on the lateral walls of a bottle case. The information carrier 100 is punched out of an adhesive foil and has an exterior side 10 facing away from the bottle case as well as an interior side 30 facing the bottle case.

In that the information carrier 100 is formed of an adhesive foil, and no glue is therefore required between the lateral surface of the bottle case and the interior side 30 of the information carrier 100, it is ensured that the information carrier remains visually attractive under any environmental conditions and weather-related influences.

Furthermore, the adhesive foil characteristic permits a simple and problem-free dispensing of the information carrier 100, which in the top view has a rectangular construction, onto the bottle case by means of a dispensing device designed for this purpose which, for reasons of clarity, is not shown in FIGS. 1 and 2.

Also, the adhesive foil characteristic not only promotes the capacity of the individual information carriers 100 to be punched out of a web-shaped (reel-type) adhesive foil, by means of flat punching (compare the first embodiment according to FIG. 1) or by means of rotatory punching (compare the second embodiment according to FIG. 2), but also a problem-free and (glue) residue-free removal of the information carrier 100 from the bottle case, which takes place after the use of the information carrier 100.

The interior side 30 of the information carrier 100 is partially provided with stampings. As a result, the degree and the strength of the adhesion of the information carrier 100 on the bottle case can be adjusted and defined.

In the first embodiment according to FIG. 1, the adhesive foil is constructed essentially in one layer of a biaxially stretched (→for the further processing, particularly for the stiffness required for the automatic and/or mechanical dispensing onto the bottle case) thermoplastic material which has two different plastic materials. In this case, the exterior side 10 and the interior side 30 are co-extruded, whereby the material-specific characteristics can be adjusted and parameterized as a function of the purpose of the information carrier 100.

Thus, the adhesive foil has material regions which extend parallel to one another in the extrusion direction and which, in an alternating manner, may have a first plastic material, specifically polyethylene (PE) or polypropylene (PP), and a second plastic material providing the adhesion characteristics, specifically 56% ethylene vinyl acrylate (EVA).

In contrast, in the second embodiment according to FIG. 2,

the exterior side 10 of the information carrier 100 is formed of a first plastic material, specifically of polyethylene terephthalate (PET),

the interior side 30 of the information carrier 100 is formed of a second plastic material providing the adhesion characteristics, specifically of approximately 4% polyisobutyl PIB) (→melting index MI approximately equal to 1), and

the exterior side 10 and the interior side 30 are laminated with one another by a bonding medium 20 in the form of a bonding agent on the basis of a copolymer.

In order to ensure, in the case of the second embodiment according to FIG. 2, a particularly intimate connection between the first plastic material and the second plastic material, the melting temperature TV of the bonding medium 20 is lower than the melting temperature TK of the first plastic material and of the second plastic material.

The partially opaquely constructed information carrier 100 is partially imprinted and partially inscribed on its exterior side 10. Furthermore, on its interior side 30, the information carrier 100 is coated with white paint in order to better set off the imprinted region of the information carrier 100 as well as the inscribed area of the information carrier 100.

1. Information carrier (100) provided for a mounting on a bottle and/or on a bottle case, particularly on the lateral surfaces of a bottle case,
which information carrier (100) is formed of an adhesive foil, in particular, is punched out, and
which has an exterior side (10) facing away from the bottle and/or from the bottle case as well as an interior side (30) facing the bottle and/or the bottle case.

2. Information carrier according to claim 1, characterized in that the interior side (30) of the information carrier (100) is provided at least partially with at least one stamping.

3. Information carrier according to claim 1 or 2, characterized in that the information carrier (100) is provided at least partially with at least one perforation and/or with at least one punching.

4. Information carrier according to at least one of claims 1 to 3, characterized in that the adhesive foil is constructed in one layer of thermoplastic material which has at least two different plastic materials.

5. Information carrier according to at least one of claims 1 to 4, characterized in that the adhesive foil has material regions which extend parallel to one another in the extrusion direction and which, in an alternating manner, have a first plastic material and a second plastic material.

6. Information carrier according to at least one of claims 1 to 5, characterized in that the adhesive foil is stretched, particularly axially stretched or particularly biaxially stretched.

7. Information carrier according to at least one of claims 1 to 6, characterized in that
the exterior side (10) of the information carrier (100) is formed of a first plastic material,
the interior side (30) of the information carrier (100) is formed of a second plastic material, and
the exterior side (10) and the interior side (30) are coextruded or are laminated with one another by at least one bonding medium (20).

8. Information carrier according to claim 7, characterized in that the first plastic material is selected from the polyamide (PA), the polyethylene (PE), the polyethylene terephthalate (PET), the polypropylene (PP), the polystyrene (PS) and/or the polyurethane (PU) group.

9. Information carrier according to claim 7 or 8, characterized in that the second plastic material is selected from the ethylene butyl acrylate (EBA), the ethylene methyl acrylate (EMA), the ethylene vinyl acrylate (EVA), the polyisobutyl (PIB), the polyisomethyl (PIM), the polyisovinyl (PIV) group and/or from Surlyn.

10. Information carrier according to at least one of claims 7 to 9, characterized in that the bonding medium (20) is at least one bonding agent.

11. Information carrier according to at least one of claims 7 to 10, characterized in that the bonding medium (20) is based on at least one copolymer.

12. Information carrier according to at least one of claims 7 to 11, characterized in that the material of the bonding medium (20) is selected from the ethylene butyl acrylate (EBA), the ethylene methyl acrylate (EMA), the ethylene vinyl acrylate (EVA) group and/or from Surlyn.

13. Information carrier according to at least one of claims 7 to 12, characterized in that the melting temperature (TV) of the bonding medium (20) is lower than the melting temperature (TK) of the first plastic material and of the second plastic material.

14. Information carrier according to claim 13, characterized in that the melting temperature (TV) of the bonding medium (20) is in the order of approximately 120° C. and/or in that the melting temperature (TK) of the first plastic material and of the second plastic material is in the order of approximately 220° C.

15. Information carrier according to at least one of claims 7 to 14, characterized in that at least one gluing agent is provided as the bonding medium 20.

16. Information carrier according to claim 15, characterized in that the gluing agent is
at least one cold gluing agent and/or
at least one thermally active gluing agent (so-called hot melt gluing agent).

17. Information carrier according to at least one of claims 1 to 16, characterized in that the information carrier (100) has an at least partially opaque construction.

18. Information carrier according to at least one of claims 1 to 17, characterized in that the information carrier (100), on its exterior side (10) and/or on its interior side (30), is
at least partially transparent and/or
at least partially dyed and/or
at least partially imprinted and/or
at least partially coated and/or
at least partially inscribed.

19. Information carrier according to claim 18, characterized in that the information carrier (100) is
at least partially imprinted with color and/or
at least partially coated with paint.

20. Information carrier according to claim 18 or 19, characterized in that the information carrier (100) is
at least partially dyed white and/or
at least partially imprinted with a white color, and/or
at least partially coated with a white paint.

21. Information carrier according to at least one of claims 18 to 20, characterized in that the imprinted region of the information carrier (100) or the imprinted area of the information carrier (100) is imprinted by letter press printing, by flexo-printing, by counterprinting, by offset printing, by silk screen printing, by laser printing, by ink jet printing, by thermotransfer printing and/or by photogravure printing.

22. Information carrier according to at least one of claims 1 to 21, characterized in that the information carrier (100) is flat punched or rotatorily punched from the adhesive foil.

23. Information carrier according to at least one of claims 1 to 22, characterized in that, in the top view. the information carrier (100) has an approximately rectangular construction.
